(19) United States
(12) Patent Application Publication
(10) Pub. No.: US 2012/0301297 A1
(43) Pub. Date: Nov. 29, 2012

(54) Fluid turbine device for power generation

(76) Inventor: Marion Ludwick, Augusta, WV (US)

(21) Appl. No.: 13/134,068

(22) Filed: May 28, 2011

(51) Int. Cl. F03D 3/06

(52) U.S. Cl. 416/17

(57) ABSTRACT

A vertical axis, fluid turbine device comprises a turbine rotor with a rotatable, central shaft and three to six, equally spaced rotor vane sections connected to the central shaft with adjacent vane sections connected to one another in a framework. This framework rotates about the central shaft with the directional passage of fluid, typically wind, therethrough. Each vane section consists of: a rectangular frame with at least two connections to the central shaft; an elongate hinge section extending substantially parallel to the central shaft and connected to the rectangular frame with two or more rotatable bearings; and a vane panel connected to the hinge section for rotating about the rectangular frame and up to about 180 degrees away from an end of the rectangular frame closest to the central shaft with passage of wind through the framework and with rotation of the rectangular frame about the central shaft. Most preferably, a crossbar extends between opposed sides of the rectangular frame for preventing over-rotation of the vane panel through its frame.

### FIELD OF THE INVENTION

This invention relates to the field of turbine devices, particularly wind turbines, and more particularly to power generation systems that employ fluid turbines having a vertical axis of rotation.

### BACKGROUND OF THE INVENTION

Numerous patents have been granted in a category of wind turbines called “vertical-axis” turbines. These turbines are so-named because they have vanes or blades displayed outward from a vertically mounted, central axis. An immediate advantage of such devices is that they need not be rotated to always face the wind. Whatever direction the wind comes from, these devices can immediately absorb wind energy and convert it to rotational power. Such devices are sometimes technically described as having their axis of rotation transverse to the flow of fluid medium.

Previous designs of vertical axis windmills generally fall into two category types, the Darrieus and Savonius rotor varieties. Many variations of the two have been designed over the years. A traditional Darrieus rotor, per U.S. Pat. No. 1,835,018, is essentially two or more long thin blades with their ends connected at the top and bottom to a vertically rotating shaft. The cross-section of long blades has an airfoil shape for transforming wind flow energy into rotational energy. Since the original Darrieus design, numerous devices have attempted to utilize aerodynamic thrust as the driving force for wind turbines.

Darrieus-type turbines have several disadvantages. Many such designs, especially those closely based on the original, are not self-starting. They require an auxiliary power source to reach operational speeds. Furthermore, in winds of 25 mph, the exposed knife blade-like rotors will travel in excess of 100 mph. Such an arrangement is hardly “avian friendly,” and indeed might pose extreme hazards to life and property. Moreover, efficiency of the original Darrieus design has been estimated to be only about 30 to 40%.

The original Savonius turbine, from U.S. Pat. No. 1,697,574, was essentially a pair of opposing concave vanes rotating around a central vertical axis. Classic Savonius rotors are open in the center and permit crossing fluid flow in an S-shape past the inner edges of these rotating vanes. Later turbine designs have increased the number of vanes, attached vanes directly to the central shaft or other blades to prevent crossing fluid flow, and/or incorporated fixed vanes (or “stators”) that do not rotate but serve to advantageously direct wind towards the rotating vanes.

Downwind moving, Savonius-type vanes provide means for capturing the wind energy impinging on their concave working surfaces. Wind cannot readily flow sideways but must deliver more of its energy into the vane surface. The concave surfaces of a Savonius-type vane prevent the easy lateral flow of wind around them. Roughly, the more concave the surface, the more energy that is not lost to lateral flow. Unfortunately, Savonius-type turbines with rigid rotor vanes suffer from drag resistance on all but the downwind part of the cycle (possibly even there too, in principle).

Other vertically-vaned arrangements include the electrical generating system of Ammons U.S. Pat. No. 4,792,700. In the cube-like, spinner cage of that concept, there was mounted at least four “spinner sails” in each of the respective cube corners. These four sails stay aligned within the cube corners for causing rotational movement of the cage with movement of the wind thereagainst. The Ammons' sails remain affixed to their respective cube corners, however.

In Corry U.S. Pat. No. 4,457,669, the jibe mill is provided with flexible sheet sails with axial movement for each being limited by a adjustable stop 51′ in a latter embodiment. Overlapping, horizontally mounted sails are the basis for wind rotation of the device disclosed in Cummings U.S. Pat. No. 5,525,037. By contrast, the plurality of blades in Hung U.S. Pat. No. 5,844,323 are limited in their respective frame compartments by the positioning between radiate skeleton arms, such as elements A and A1 in FIG. 7 of that patent.

For Strickland U.S. Pat. No. 3,743,848, each horizontal arm to that wind driven apparatus is provided with a plurality of rotationally mounted vanes. Finally, Gaston U.S. Pat. No. 4,494,007 shows its own wind machine with a plurality of blades capable of rotating a full 360 degrees about their central shaft connections.

What is needed is a vertical, mechanical device that uses bearing tech knowledge to create energy transference from a natural fluid (liquid or gas) for efficiently making electrical and/or mechanical power. It is desired to provide a vertical wind generation device that overcomes the resistance effect when capturing wind power experienced by many known turbine devices. Such devices routinely capture the wind with a required foil on the drive side. But that same foil causes resistance on the non-drive side. That resistance depletes the overall effectiveness of wind-to-power conversion from these prior art generators.

### SUMMARY OF THE INVENTION

The present invention improves on many known vertical turbine configurations. It achieves a transfer of energy with wind for most every natural setting such as valleys, hilltops, along ridges and even many coastal areas. Alternatively, it can be used for power generation from the flowing water energy of streams and rivers, tide waters (especially where tides are directed through restricted flow regions to fill inland voids) and for wave energies (along coastal areas where wave energies become more concentrated).

With the present invention, end use applications can be rather diverse. This design can be used to help lower the energy costs of individual homes, whole communities, throughout the nation and also in many/most underdeveloped countries of the world.

Preferred embodiments exploit three points of conversion tech knowledge. This design employs a stable platform for holding elements or segments while still allowing for the free movement of wind (or water) against such elements/segments. Conversion portions of the same achieve minimal resistance when converting wind or water movement into useable power. And, this arrangement shows how to convert that power into a useable, natural energy source.

Keeping a platform stable is not easy. The design of this invention has a built in bolt pattern for firmly securing onto its wind (or water) power conversion unit. Alternatively, it can be mounted onto axles for greater mobility. This invention may be scaled up or down, as needed, to various sizes with larger units exhibiting more natural stability.

The rotating platform of this invention represents an excellent way to increase the energy efficiency of a vertical wind power generator. With its rotating platform design, the invention captures energy on one side but avoids the resistance of energy on the opposite side. This is accomplished with a 180 degree release of air foils on the opposite side with a 180 degree “lock” on the capture side. This is accomplished by hinging a plurality of foils (or sails), preferably between three to six segmented units, to the outside frame of a vertical, rotating central hub. The foil for each segment would be “closed” on the wind energy capture side while being free flowing on the opposite side . . . working much like a wind vane depending on the direction of wind flow therethrough. At the opposite side of each foil, the energetic flow of gases/liquids are “caught” by the fluid causing each foil to flip around and become nearly non-resistant.

This invention can convert fluid movement via the center axis in several ways. Electricity can be generated through a built in, direct current generator preferably situated directly below the stable platform of same. Energy transference can also be achieved through a wheel and belt system or via known gear drive arrangements.

Herein, a vertical axis, fluid turbine device comprises a turbine rotor with a rotatable, central shaft and three to six, equally spaced rotor vane sections connected to the central shaft with adjacent vane sections connected to one another in a framework. This framework rotates about the central shaft with the directional passage of fluid, typically wind, there through. Each vane section consists of: a rectangular frame with at least two connections to the central shaft; an elongate hinge section extending substantially parallel to the central shaft and connected to the rectangular frame with two or more rotatable bearings; and a vane panel connected to the hinge section for rotating about the rectangular frame and up to about 180 degrees away from an end of the rectangular frame closest to the central shaft with passage of wind through the framework and with rotation of the rectangular frame about the central shaft. Most preferably, a crossbar extends between opposed sides of the rectangular frame for preventing over-rotation of the vane panel through its frame.

### DESCRIPTION OF THE DRAWINGS

Further features, objectives and advantages of the present invention will become clearer when referring to the following detailed description made with reference to the drawings in which:

FIG. 1 is a top perspective view of one preferred embodiment with no wind passing through so that all panel segments are closed;

FIG. 2 is a top perspective view of the FIG. 1 embodiment with a directional wind passing from left to right through same;

FIG. 3 is a top plan view of the embodiment from FIG. 2;

FIG. 4 is a front view of the exterior to one vane panel for attaching to the central shaft along its right vertical axis;

FIG. 5 is a front plan view of the interior to the vane panel from FIG. 4; and

FIG. 6 is a side view of one embodiment of lower central brace for connecting the framework of vane panels to a spindle through which rotational energy from this turbine may be transmitted.

### DESCRIPTION OF PREFERRED EMBODIMENTS

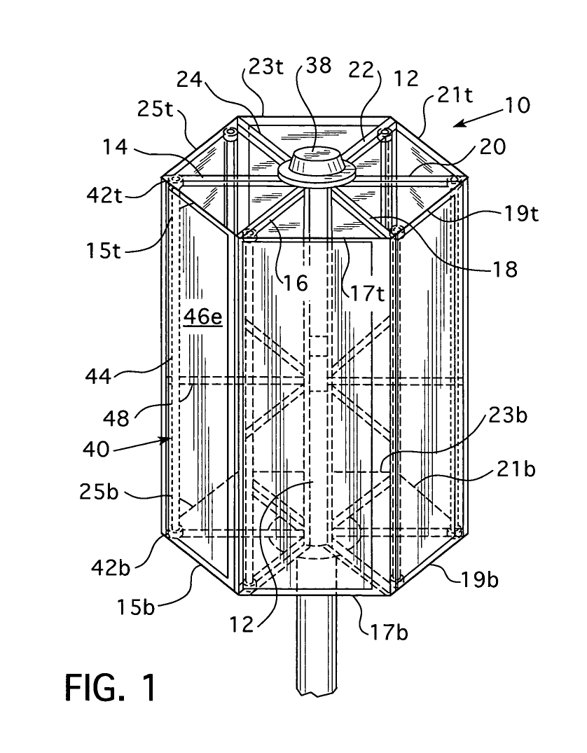

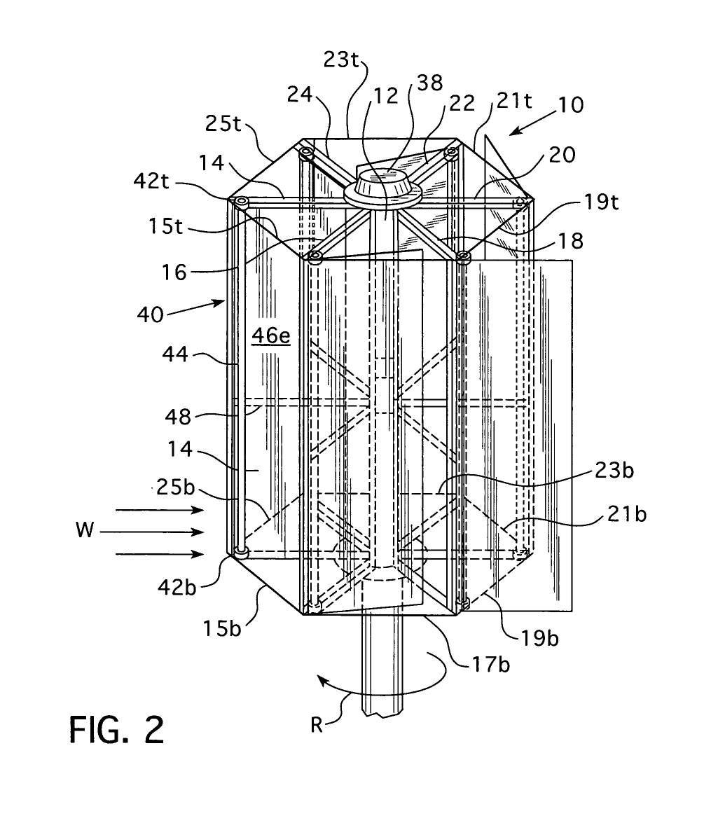

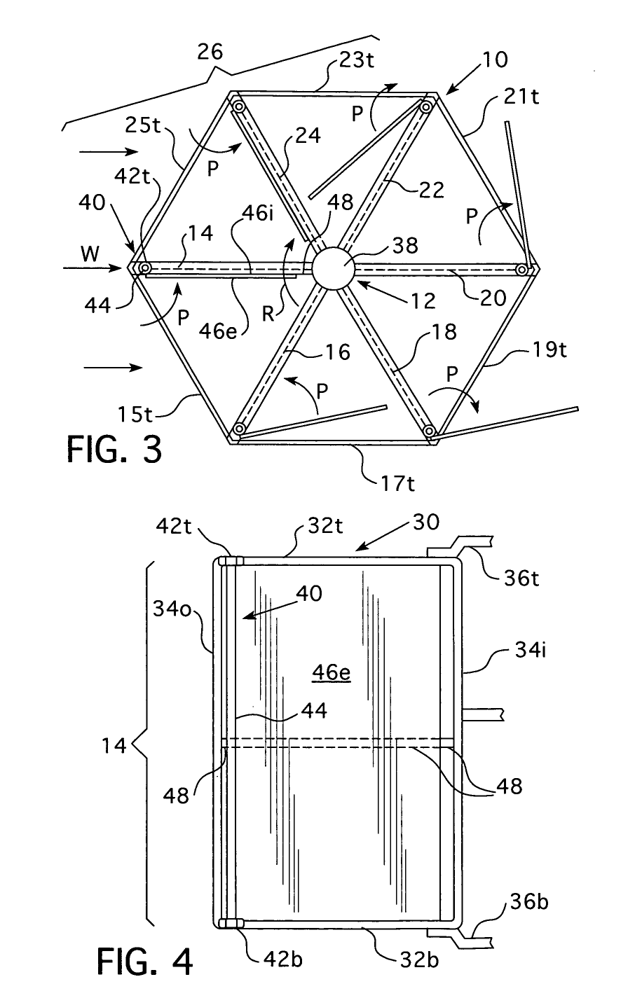

Referring now to FIGS. 1 through 3, there is shown one embodiment of fluid turbine device, generally 10, according to this invention. In FIG. 1, the perspective view is of the device at rest, i.e. with no wind (water, or other fluid for that matter) flowing therethrough or thereagainst to start rotation of the device in response. FIG. 2 takes the same view of device 10 but with a representative wind (indicated by arrows W) flowing from left to right in this view. FIG. 3 is a top view of the wind moved, turbine device 10 from FIG. 2.

More particularly, device 10 comprises a rotatable, central shaft 12 and plurality of rotor vane sections 14, 16, 18, 20, 22, 24 connected to central shaft 12. In this preferred embodiment, six (pie-shaped) vane sections are shown adjacent one another and surrounding central shaft 12 though it is to be understood that as few as three (3), equally spaced vane sections would suffice at perhaps lesser efficiency.

Adjacent vane sections of this embodiment are connected to one another with at least two connector means. As shown, there are connector cables joining the top 15t and bottom 15b of adjacent vane sections 14 and 16. Similarly, a pair of connector cables 17t and 17b join adjacent sections 16 and 18; cables 19t and 19b between sections 18 and 20; cables 21t and 21b between sections 20 and 22; cables 23t and 23b between sections 22 and 24; and finally, connectors 25t and 25b between vane sections 24 and 14. Cumulatively, this combination of vane sections with top and bottom cables creates an effective framework, generally 26, for rotating about central shaft 12 with the directional passage of wind through said framework 26. In FIGS. 2 and 3, arrows W indicate an initial wind direction (from left to right on the page). It is understood, however, that wind directions frequently change in nature. The framework 26 of this invention accommodates numerous wind changes and allows for overall device rotation (arrow R) in either a clockwise, or counterclockwise rotation. With the left-to-right direction of wind W against device 10 in FIGS. 2-3, there is an overall device rotation R in a clockwise direction.

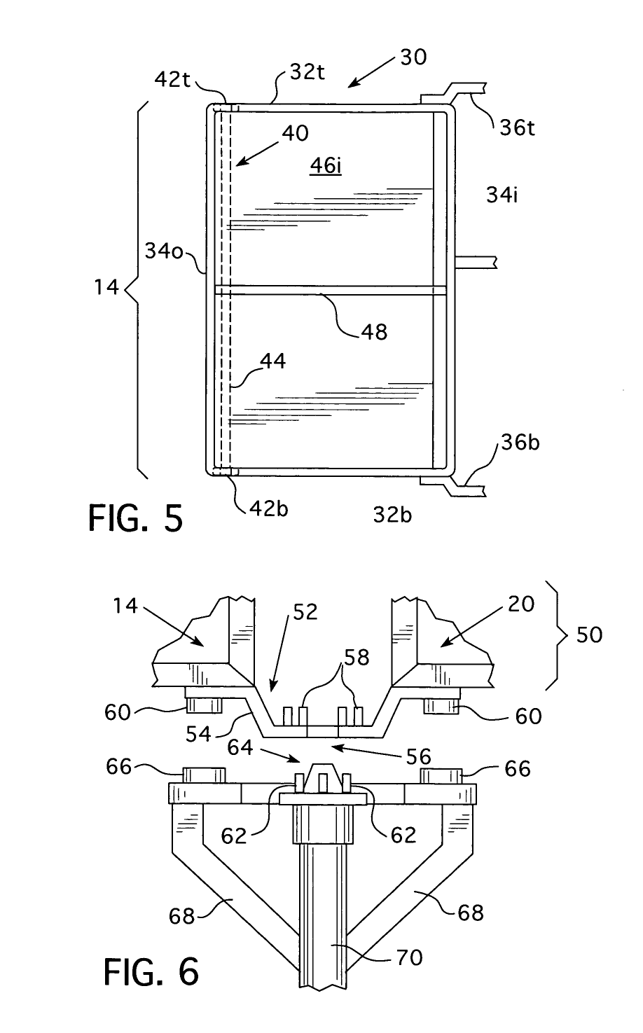

As better seen in FIGS. 4 and 5, representative vane section 14 comprises a substantially polygonal, preferably rectangular frame, generally 30. In this embodiment, frame 30 is made up of two sets (or pairs) of substantially parallel components, top an bottom bars, 32t and 32b, respectively, for running substantially horizontal and also substantially parallel to the mounting surface (whether that be the ground, a building rooftop and/or movable-portable platform. At the corners to frame 30, top and bottom bars 32t and b, intersect with the pair of substantially, parallel running, vertically extending “sidebars” one closer to central shaft 12 being designated inner bar 34i with its opposite, outermost extending counterpart, outer bar 34o. Note that for the other vane sections in FIGS. 1 through 3, numbered 16, 18, 20, 22 and 24 therein, there are corresponding top, bottom, inner and outer sidebar frame component equivalents.

In this embodiment, all frame components and interconnecting cables are made of metal, preferably aluminum or lightweight steel. Depending on overall device size, however, smaller versions may include some or many component substitutes made from plastics, resins and/or composite blends.

For each vane section of framework 26, there are at least two connections to central shaft 12, a top hub 36t and bottom hub 36b. As shown, these both consist of angle brackets though any suitable frame-to-central shaft connector may also suffice. In the accompanying FIGS, these two hubs 36t and 36b join to the top 32t and bottom bars 32b closest to inner sidebar 34i. For component protection, the top hubs to all six vane sections may be covered with a single, durable outer cap 38.

Back to FIGS. 4 and 5, representative vane section 14 also includes an elongate hinge section, generally 40, that extends substantially parallel to central shaft 12 closest to outer sidebar 34o. Hinge section 40 includes two rotatable bearings, i.e. a top bar bearing 42t and a bottom bar bearing 42b between which an elongated, vertically extending hinge bar 44 is situated. Attached to that hinge bar is a vane panel 46. For ease of illustration, the vane panel exterior (46e) is shown in FIG. 4 with vertical hatchings so as to distinguish it from its interior (46i) as lined horizontally in FIG. 5. With similar lining for the other vane panels, one can better ascertain whether a panel exterior or interior is seen in those views (FIGS. 2 and 3) where wind has been directionally driven through device 10.

Representative vane panel 46 may be welded or otherwise permanently connected to the hinge bar 44 for that vane section 14. As wind forces contact the device 10, the “combination” of hinge bar 44 and vane panel 46 will rotate between bearings 42t and 42b, up to about 180 degrees (as shown by panel rotation arrows P) like a swing with a purposefully limited range. In order to prevent the panels from overly rotating about, and then not being able to return to a useable, rotation position with rotation of the framework 26 about its central shaft 12, each vane section is provided with panel rotation prevention means. In this case, the latter consists of a crossbar 48 between opposed sides of the frame 30. Herein, crossbar 48 extends substantially horizontally between inner sidebar 34i and outer bar 34o. In doing so, it also provides the vane section 14 with some internal bracing for greater overall stability. Alternatively, a single crossbar (not shown) could extend vertically between top 32t and bottom bars 32b; or possibly extend at least partially diagonally between adjacent arms of the same vane section as in an interconnector from top bar 32t and then downwards to inner sidebar 34i, with a corresponding crossbar beam (again, not pictured) extending from outer sidebar 34o to bottom bar 32b.

In preferred embodiments, each vane panel 46 proper is made from a sufficiently rigid material that will accept wind forces and cause a swing or sail-like movement about the hinge bar 44 to which it is permanently attached. Accordingly, one embodiment uses sheet metal, most preferably aluminum or light steel sheet for its panels. In still other variations, plastic and/or cloth sail sections may be incorporated into this device, either alone or combination with metal panel frame subsections.

FIG. 6 shows a close up view to one lower end, generally 50, of a device 10 slightly raised over before connecting to its own spindle base, generally 52. Therein, lower end 48 includes a plurality of lower brackets 54 for connecting to sections of framework 26, more particularly to the undersides of several (if not all six) bottom bars 32b. In a central region 56 of lower end 50, there are several recesses 58 and along the underside to lower brackets 54, there are several magnetic coils 60. The former recesses 58 are meant to lock around (or at least partially between) raised teeth 62 to the central cap 64 of spindle base 52. Several matching spindle magnets 66 are aligned to interact with magnetic coils 60 of lower end 50 for helping to properly center framework 26 over its base and eventually, firmly connect thereto. For still better support, spindle base 52 includes a plurality of brace arms 68 about its center shaft 70. The latter shaft 70 then connects elsewhere to an electrical generator, water pump or other energy collection means (not shown).

Preferred embodiments of this invention include a plurality, preferably three to six, polygonal, roughly rectangular vane sections disposed symmetrically about a vertical axis. These vane sections each connect to a common central support/shaft that rotates about its vertical axis to supply power to turn a generator or water pump. Most preferably, the rotation of these vane sections is caused by wind force.

The generally hexagonal framework 26 funnels wind forces towards the vane panels (sails or “foils”) of the vane sections for transferring wind forces into rotational movement of the device proper. At times, some vane panels are not presented “to the wind” resulting in some air resistance (or “drag”). That acts to commence temporary panel closure by transferring wind energies to the rear (or interior) surface of that vane panel. It is believed that the speed at which the device rotates will assume the same speed as the wind passing through it so that a device impacted with winds of about 5 mph will, itself, rotate up to about 5 mph.

Each vane panel is connected to its frame by suitable supporting material, the ultimate strength and attachment design of which will adequately support the vanes even under extreme wind conditions and long-term exposure to differing weather. Each vane panel itself is constructed of sufficiently reinforced materials for withstanding these same varying weather conditions.

It is not known what size or shape of vane panel will most efficiently capture wind energy and convert same to rotational energy in the rotor. These may be variable depending on average ambient wind speeds and amount of turbulence for a given location. It is also not currently known whether a device with three, four or five sections may yield higher efficiencies than the six paneled system described above, again perhaps depending on variables of average wind speed and turbulence. One may also have to give due consideration to: having an open center region, i.e., between the “faces” of adjoining vane panels; or staggering such openings relative to one another. It may not be possible at this time to adequately predict, in theory, the most efficient design for a variety of conditions. Only through testing of experimental prototypes can such assessments be determined. The preferred embodiments will utilize the optimally efficient shape, depth, number of vane panels, and open or closed center areas for differing applications and locations.

The present invention may run water pumps instead of electric generators. Indeed, water pumps are much less expensive to manufacture, maintain and replace than electric generators (a cost differential likely to increase if copper prices continue to soar), and it makes a good deal of sense to employ a system that minimizes the number of electric generators. The same concept could be applied to wind generators on the tops of tall buildings, permitting energy storage in water tanks at the top of a building before utilizing a mini-hydroelectric plant at ground level when demand for electricity gets high.

The present invention is a safe design that makes it suitable for transporting to and installing on many building rooftops. In addition, there is no reason why the electricity produced by such systems could not be diverted (wholly or partially) to other uses/needs. For tall building systems, pumped and stored water could be used to supply the fresh water needs of that building and additional waters electrically heated for same. The additional technologies involved, essentially water pump, water tank storage, and hydroelectric technologies are simple, known and cost-effective.

The foregoing discussion discloses and describes merely exemplary embodiments of the present invention. One skilled in the art will readily recognize from such discussion, and from the accompanying drawings and claims, that various changes, modifications and variations can be made therein without departing from the spirit and scope of the invention.

What is claimed is:

1. A vertical axis, fluid turbine device comprising:
a turbine rotor with a rotatable, central shaft and a plurality of rotor vane sections connected to the central shaft with adjacent vane sections connected to one another in a framework for rotating about the central shaft with directional passage of a fluid through the framework, each vane section comprising:
a substantially polygonal frame with at least two connections to the central shaft;
an elongate hinge section extending substantially parallel to the central shaft and connected to the polygonal frame with at least two rotatable bearings; and
a vane panel connected to the hinge section for rotating about the polygonal frame and up to about 180 degrees away from an end of the polygonal frame closest to the central shaft with passage of the fluid through the framework and with rotation of the polygonal frame about the central shaft.

2. The fluid turbine device of claim 1 wherein each vane section further includes means for preventing the vane panel from rotating past a point parallel to and at least partially through the polygonal frame.

3. The fluid turbine device of claim 2 wherein the vane panel prevention means includes a crossbar between opposed sides of the polygonal frame.

4. The fluid turbine device of claim 3 wherein the crossbar extends between substantially vertically extending sides of the polygonal frame.

5. The fluid turbine device of claim 1 wherein at least some of the vane panels are made from sheet metal.

6. The fluid turbine device of claim 5 wherein the vane panels are made from aluminum sheet.

7. The fluid turbine device of claim 1 wherein at least some of the vane panels are made from plastic or cloth.

8. The fluid turbine device of claim 1, which includes three to six rotor vane sections.

9. The fluid turbine device of claim 8, which includes six rotor vane sections.

10. The fluid turbine device of claim 1 wherein the fluid is wind.

11. The fluid turbine device of claim 1 wherein the fluid is water.

12. The fluid turbine device of claim 1, which further includes a lower central brace for the framework to removably connect to a spindle through which rotational energy from this turbine may be transmitted.

13. The fluid turbine device of claim 12 wherein the spindle connects to an electric generator.

14. The fluid turbine device of claim 12 wherein the spindle connects to a water pump.

15. A vertical axis, wind turbine device comprising:
a turbine rotor with a rotatable, central shaft and from three to six, equally spaced rotor vane sections connected to the central shaft with adjacent vane sections connected to one another in a framework for rotating about the central shaft with directional passage of wind through the framework, each vane section comprising:
a substantially polygonal frame with two or more connections to the central shaft;
an elongate hinge section extending substantially parallel to the central shaft and connected to the polygonal frame with upper and lower rotatable bearings;
a vane panel connected to the hinge section for rotating about the polygonal frame and up to about 180 degrees away from an end of the polygonal frame closest to the central shaft with passage of wind through the framework and with rotation of the polygonal frame about the central shaft; and
means for preventing the vane panel from rotating past a point parallel to and at least partially through the polygonal frame.

16. The wind turbine device of claim 15 wherein the vane panel prevention means includes a crossbar between opposed, substantially vertical sides of the polygonal frame.

17. The wind turbine device of claim 15, which includes six rotor vane sections.

18. The wind turbine device of claim 15 wherein the vane panels are made from sheet metal, plastic, cloth and combinations thereof.

19. The wind turbine device of claim 18 wherein the vane panels are made from aluminum sheet.

20. A vertical axis, wind turbine device comprising:
a turbine rotor with a rotatable, central shaft and six, equally spaced rotor vane sections connected to the central shaft with adjacent vane sections connected to one another in a framework for rotating about the central shaft with directional passage of wind through the framework, each vane section comprising:
a rectangular frame with at least two connections to the central shaft;
an elongate hinge section extending substantially parallel to the central shaft and connected to the rectangular frame with two or more rotatable bearings;
a vane panel connected to the hinge section for rotating about the rectangular frame and up to about 180 degrees away from an end of the rectangular frame closest to the central shaft with passage of wind through the framework and with rotation of the rectangular frame about the central shaft; and
a crossbar that extends between opposed sides of the rectangular frame.
